(19) United States
(12) Patent Application Publication
(10) Pub. No.: US 2026/0314561 A1
(43) Pub. Date: Oct. 15, 2026

(54) SELF-CALIBRATING ROTARY WEIGHING STRUCTURE AND PET WATER DISPENSER INCORPORATING SAME

(71) Applicant: PET GRAVITY (HANGZHOU) TECHNOLOGY CO., LTD, Hangzhou (CN)

(72) Inventors: Lijun WANG, Zibo (CN); Xianfu CAO, Ganzhou (CN)

(21) Appl. No.: 19/710,084

(22) Filed: Jun. 16, 2026

Related U.S. Application Data
(63) Continuation of application No. PCT/CN2025/099384, filed on Jun. 5, 2025.

(30) Foreign Application Priority Data
Jun. 3, 2025 (CN) 202521114915.5

(51) Int. Cl. A01K 7/02

(52) U.S. Cl. CPC A01K 7/02

(57) ABSTRACT

Disclosed are a self-calibrating rotary weighing structure and a pet water dispenser incorporating the same. The structure includes a load cell, a drive assembly, a drinking bowl, a bowl connecting member and a bushing assembly. One end of the load cell is connected to the drive assembly, and the other end thereof is connected to the drinking bowl. The end of the load cell connected to the drinking bowl is disposed in a suspended manner. The drive assembly drives the drinking bowl to rotate through the load cell. The drinking bowl is mounted on one end of the bushing assembly via the bowl connecting member, and the load cell is detachably mounted on the other end of the bushing assembly; and the load cell is a beam-type load cell. The present disclosure arranges the load cell between the drinking bowl and the drive assembly, thereby forming a dual-function metering system.

### CROSS-REFERENCE TO RELATED APPLICATIONS

This application is a continuation of International Application No. PCT/CN2025/099384, filed on Jun. 5, 2025, which claims priority to Chinese Patent Application No. 202521114915.5, filed on Jun. 3, 2025, both of which are hereby incorporated by reference in their entireties.

### TECHNICAL FIELD

The present disclosure relates to the technical field of pet supplies, and in particular to a self-calibrating rotary weighing structure and a pet water dispenser incorporating the same.

### BACKGROUND

With the deep integration of the pet economy and the concept of smart pet care, modern pet water dispensers have already achieved the basic function of water intake volume monitoring; however, their core technology still suffers from significant defects: existing devices mostly adopt a differential weight method of the total water tank to estimate single water intake per drinking event. This approach forces a load cell to sustain a static load of several kilograms over an extended period of time. Under the influence of material deformation characteristics and sustained stress effects, a sensitive element of the sensor inevitably experiences a creep effect. Combined with nonlinear drift caused by temperature and humidity fluctuations during long-term operation, this will lead to composite measurement distortion. More critically, due to structural limitations of the device, traditional solutions cannot implement periodic calibration, causing errors to exhibit irreversible and cumulative amplification and resulting in measurement accuracy that has already completely deviated from the precision requirements of scientific pet care. This systemic deviation not only renders health management functions, such as early warning and screening for chronic diseases, effectively meaningless, but may also delay the optimal window for diagnosis and treatment of pet illnesses due to data distortion.

### SUMMARY

An objective of the present disclosure is to provide a self-calibrating rotary weighing structure and a pet water dispenser incorporating the same to solve the above problems, as described in detail below.

In order to achieve the foregoing objective, the present disclosure adopts the following technical solution:

The present disclosure provides a self-calibrating rotary weighing structure, including a load cell, a drive assembly, and a drinking bowl. One end of the load cell is connected to the drive assembly, and the other end thereof is connected to the drinking bowl. The end of the load cell connected to the drinking bowl is disposed in a suspended manner. The drive assembly drives the drinking bowl to rotate through the load cell, thereby enabling liquid in the drinking bowl to be poured out.

Preferably, the self-calibrating rotary weighing structure further includes a bowl connecting member and a bushing assembly; where the drinking bowl is mounted on one end of the bushing assembly via the bowl connecting member, the load cell is detachably mounted on the other end of the bushing assembly, and the load cell is a beam-type load cell.

Preferably, the bushing assembly includes a first bushing and a second bushing; the first bushing is sleeved over the second bushing, the first bushing is provided with a first hole, and the second bushing is provided with a second hole; and the first hole is in fluid communication with the second hole, such that an inner cavity of the first bushing is in fluid communication with an exterior through the second hole. The bowl connecting member is detachably mounted beneath the first bushing, the second bushing is provided with a load cell mounting hole, and the load cell is detachably mounted within the load cell mounting hole.

Preferably, the drive assembly includes a drive motor and a rotating assembly, and the drive motor is connected to one end of the rotating assembly, such that the drive motor drives the rotating assembly to rotate, and the other end of the rotating assembly is connected to the load cell.

Preferably, the drive assembly further includes a transmission assembly, the drive motor is connected to one end of the rotating assembly via the transmission assembly, such that the drive motor drives the rotating assembly to rotate; and the other end of the rotating assembly is connected to the load cell.

The present disclosure further provides a pet water dispenser incorporating the above self-calibrating rotary weighing structure, including a first housing and a water pump; the first housing is provided with a first space configured to contain clean water, one end of the water pump is in fluid communication with the first space, the other end thereof is in fluid communication with the drinking bowl, and the water pump is configured to pump the clean water from the first space into the drinking bowl.

Preferably, the water pump is in fluid communication with the first hole and the second hole, thereby communicating with the drinking bowl through the first hole, the second hole, and the inner cavity of the first bushing.

Preferably, the pet water dispenser further includes a second housing; the second housing is provided with a second space, and the water pump and the drive assembly are both accommodated within the second space; a third hole is formed in a side wall of the second housing, the bushing assembly passes through the third hole, and a gap is formed between the bushing assembly and a hole wall of the third hole, such that the bushing assembly is spaced apart from the hole wall of the third hole under a pressure exerted by the drinking bowl.

Preferably, the rotating assembly, along a rotational path thereof, defines at least a first position corresponding to a state in which the drinking bowl is configured to contain water and a second position corresponding to a state in which the drinking bowl is configured to pour out water. Under the driving of the drive motor, the rotating assembly is configured to perform reciprocating movement between the first position and the second position. The drive assembly further includes a position detection assembly. The position detection assembly is communicatively connected to the drive motor and is configured to transmit a signal indicating that the rotating assembly rotates to the first position and the second position to the drive motor.

Preferably, the position detection assembly includes a sensing member, a first position detection element, and a second position detection element. The sensing member is connected to the rotating assembly to rotate along with the rotating assembly. The sensing member defines, along a rotational path thereof, at least a third position corresponding to the first position and a fourth position corresponding to the second position. The first position detection element and the second position detection element are both communicatively connected to the drive motor. The first position detection element is configured to detect that the sensing member is located at the third position and transmit a signal indicating that the sensing member is located at the third position to the drive motor. The second position detection element is configured to detect that the sensing member is located at the fourth position and transmit a signal indicating that the sensing member is located at the fourth position to the drive motor.

The present disclosure has the following beneficial effects: through an innovative structural design, the present disclosure arranges the load cell between the drinking bowl and the drive assembly, thereby forming a dual-function metering system. When a pet is drinking water, the load cell acquires single water intake volume data in real time. After the drinking bowl completes liquid pouring through the rotating assembly, the system leverages the mechanical characteristics of no-load reset of a bowl body to automatically trigger a sensor zero-point calibration procedure, thereby effectively eliminating cumulative errors caused by material creep, temperature drift, or long-term loading of the load cell itself. The present disclosure innovatively addresses the problem of irreversible creep distortion caused by continuous exerted by the water tank on the load cell in traditional pet water dispensers, and simultaneously breaks through the limitation in the prior art that automatic periodic calibration cannot be implemented.

### BRIEF DESCRIPTION OF THE DRAWINGS

In order to more clearly illustrate the technical solution in embodiments of the present disclosure or in the prior art, a brief introduction to the accompanying drawings required for the description of the embodiments or the prior art will be provided below. Obviously, the accompanying drawings in the following description are merely some embodiments of the present disclosure. Those of ordinary skill in the art would also derive other accompanying drawings from these accompanying drawings without making inventive efforts.

FIG. 1 is a schematic diagram of a three-dimensional structure of the present disclosure.

FIG. 2 is an exploded view of the present disclosure.

FIG. 3 is a cross-sectional view of the present disclosure.

FIG. 4 is a schematic structural diagram of a main control board, a drive assembly, and a drinking bowl of the present disclosure.

FIG. 5 is a schematic structural diagram of a drive assembly and a drinking bowl of the present disclosure.

Reference numerals in the accompanying drawings:
1. load cell; 2. drive assembly; 201. drive motor; 202. rotating assembly; 203. transmission assembly; 204. front housing; 205. rear housing; 3. drinking bowl; 4. bowl connecting member; 5. bushing assembly; 501. first bushing; 5011. first hole; 502. second bushing; 5021. second hole; 5022. load cell mounting hole; 6. first housing; 7. water pump; 8. second housing; 801. third hole; 9. position detection assembly; 901. sensing member; 902. first position detection element; 903. second position detection element; and 10. main control board.

### DESCRIPTION OF EMBODIMENTS

In order to facilitate a better understanding of the present disclosure, the present disclosure will be described below in a more comprehensive manner with reference to the accompanying drawings. Preferred embodiments of the present disclosure are illustrated in the accompanying drawings. However, it should be understood that the present disclosure may be implemented in many different forms and is not limited to the embodiments described herein. On the contrary, the purpose of providing the embodiments is to make the disclosure of the present disclosure more thorough and comprehensive.

It should be noted that if an element is considered to be “fixed to” the other element, it means that the element may be mounted directly or indirectly on the other element, or intervening elements may also be present. When an element is considered to be “connected” to another element, the element may be directly connected to another element or there may be an intermediate element simultaneously. The terms “vertical,” “horizontal,” “left,” “right,” and the like as used herein are for illustrative purposes only.

Unless otherwise defined, all technical and scientific terms mentioned herein have the same meaning as commonly understood by those skilled in the technical field of the present disclosure. The terms used in the specification of the present disclosure herein are just for the purpose of describing particular embodiments, and are not intended to limit the present disclosure. As used herein, the term “and/or” includes any and all combinations of one or more relevant listed items.

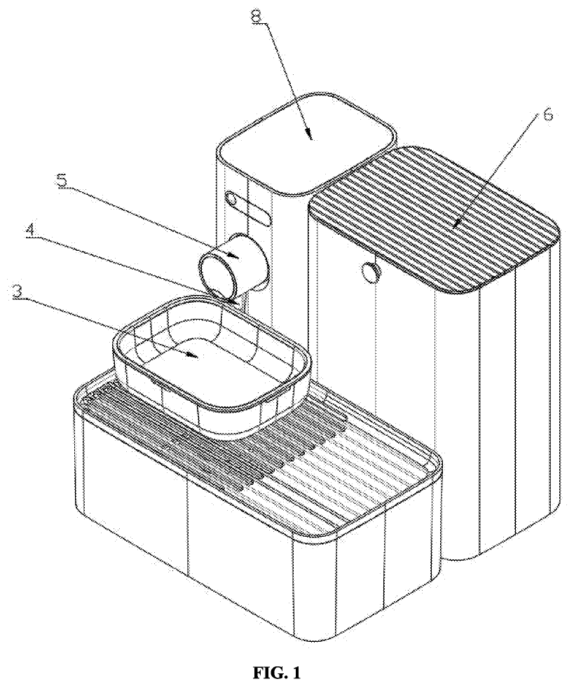

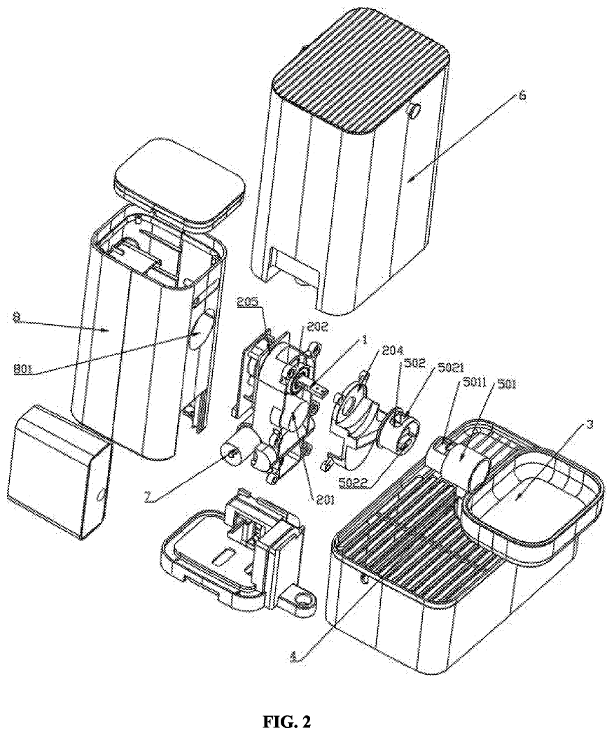

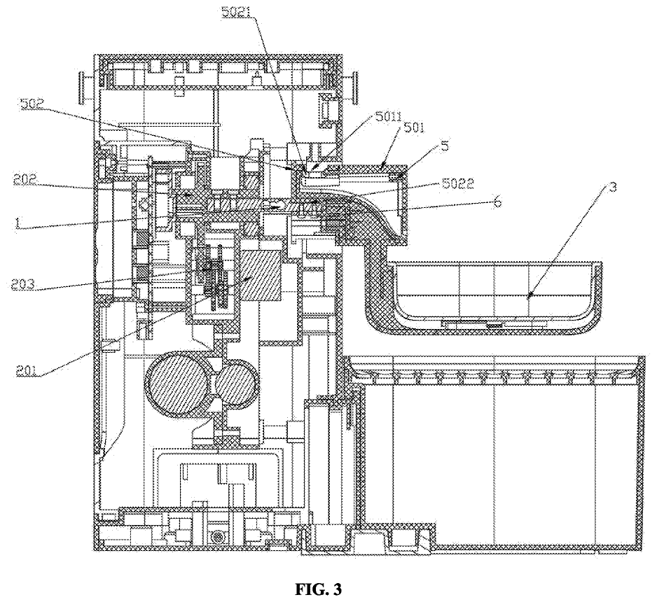

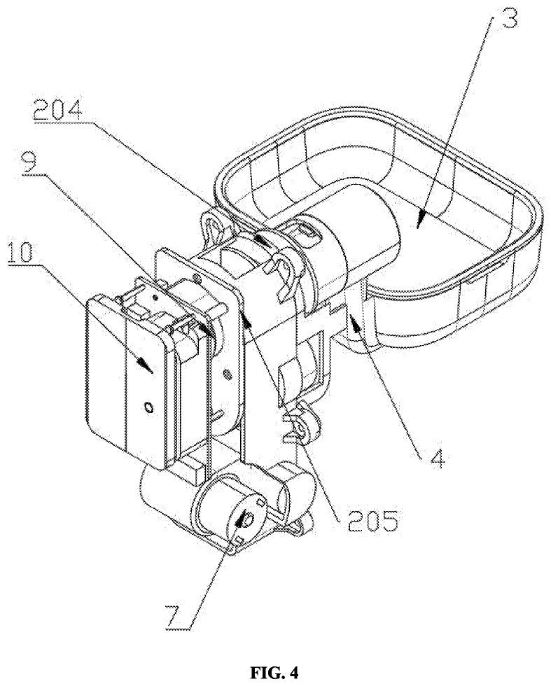

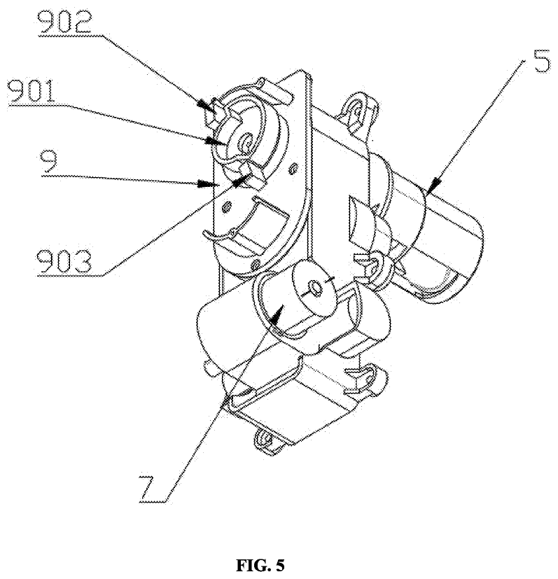

Referring to FIGS. 1-5, the present disclosure provides a self-calibrating rotary weighing structure, including a load cell 1, a drive assembly 2, and a drinking bowl 3. One end of the load cell 1 is connected to the drive assembly 2, and the other end thereof is connected to the drinking bowl 3. The end of the load cell 1 connected to the drinking bowl 3 is disposed in a suspended manner. The drive assembly 2 drives the drinking bowl 3 to rotate through the load cell 1, thereby enabling liquid in the drinking bowl 3 to be poured out. This embodiment not only solves the technical problems of water replacement and the separation of clean water and contaminated water in existing pet water dispensers, but also enables accurate measurement of a pet's single water intake volume. This embodiment adopts a dynamic cyclic measurement mechanism to achieve high-precision water intake metering: when a water-filling stage is completed, the load cell 1 records an initial water volume value; and a pet drinking behavior triggers a secondary measurement, and a single water intake volume is accurately determined through a differential calculation. After completion of measurement, a drive motor 201 drives the drinking bowl 3 to perform a rotational drainage action. By leveraging the mechanical characteristics of no-load reset of a bowl body, a sensor zero-point calibration procedure is automatically triggered, thereby eliminating errors caused by material creep and residual mechanical stress.

In this embodiment, a bowl connecting member 4 and a bushing assembly 5 are further arranged between the drinking bowl 3 and the load cell 1. The drinking bowl 3 is mounted on one end of the bushing assembly 5 via the bowl connecting member 4, and the load cell 1 is detachably mounted on the other end of the bushing assembly 5.

In this embodiment, the load cell 1 may be a beam-type load cell.

In this embodiment, the bushing assembly 5 includes a first bushing 501 and a second bushing 502. The first bushing 501 is sleeved over the second bushing 502, the first bushing 501 is provided with a first hole 5011, and the second bushing 502 is provided with a second hole 5021. The first hole 5011 is in fluid communication with the second hole 5021, such that an inner cavity of the first bushing 501 is in fluid communication with an exterior through the second hole 5021. The bowl connecting member 4 is detachably mounted beneath the first bushing 501, the second bushing 502 is provided with a load cell mounting hole 5022, and the load cell 1 is detachably mounted within the load cell mounting hole 5022. The bushing assembly 5 can not only support the installation and rotation of the drinking bowl 3, but also allow water to flow into the drinking bowl 3 through the first hole 5011, the second hole 5021, and the inner cavity of the first bushing 501, thereby avoiding the arrangement of complicated water conduits.

In this embodiment, the drive assembly 2 includes a drive motor 201 and a rotating assembly 202. The drive motor 201 is connected to one end of the rotating assembly 202, such that the drive motor 201 drives the rotating assembly 202 to rotate, and the other end of the rotating assembly 202 is connected to the load cell 1. Specifically, an output shaft of the drive motor 201 may be directly and coaxially connected to the rotating assembly 202 to drive the rotating assembly 202 to rotate; alternatively, a gear may be disposed on the output shaft, and a toothed portion may be disposed on an outer periphery of the rotating assembly 202, such that the drive motor 201 drives the rotating assembly 202 to rotate by meshing the gear with the toothed portion.

Furthermore, the drive assembly 2 further includes a transmission assembly 203. The drive motor 201 is connected to one end of the rotating assembly 202 via the transmission assembly 203, such that the drive motor 201 drives the rotating assembly 202 to rotate, and the other end of the rotating assembly 202 is connected to the load cell 1. The transmission assembly 203 may be a reduction gear set.

The present disclosure further provides a pet water dispenser incorporating the above self-calibrating rotary weighing structure, including a first housing 6 and a water pump 7. The first housing 6 is provided with a first space configured to contain clean water. One end of the water pump 7 is in fluid communication with the first space, and the other end thereof is in fluid communication with the drinking bowl 3. The water pump 7 is configured to pump the clean water from the first space into the drinking bowl 3. It should be understood that the water pump 7 has a pump inlet and a pump outlet. The pump inlet may be in fluid communication with the first space through a conduit, and similarly, the pump outlet may also be in fluid communication with the drinking bowl 3 through a conduit.

In this embodiment, the water pump 7 is in fluid communication with the first hole 5011 and the second hole 5021, thereby communicating with the drinking bowl 3 through the first hole 5011, the second hole 5021, and the inner cavity of the first bushing 501. The bushing assembly 5 can not only support the installation and rotation of the drinking bowl 3, but also allow water to flow into the drinking bowl 3 through the first hole 5011, the second hole 5021, and the inner cavity of the first bushing 501, thereby avoiding the arrangement of complicated water conduits.

Preferably, a main control board 10 may further be disposed, and the water pump 7, the drive motor 201, and the position detection assembly 9 are all communicatively connected to the main control board 10. By introducing the main control board 10, signals may be received for controlling the water pump 7 and start and stop the drive motor 201. For example, when the position detection assembly 9 detects that the rotating assembly 202 rotates from the second position to the first position, the main control board 10 may control the water pump 7 to pump the clean water from the first space into the drinking bowl 3, thereby improving the level of automation.

In this embodiment, the pet water dispenser further includes a second housing 8. The second housing 8 is provided with a second space. The water pump 7 and the drive assembly 2 are both accommodated within the second space. A third hole 801 is formed in a side wall of the second housing 8. The bushing assembly 5 passes through the third hole 801, and a gap is formed between the bushing assembly 5 and a hole wall of the third hole 801, such that the bushing assembly 5 is spaced apart from the hole wall of the third hole 801 under a pressure exerted by the drinking bowl 3. By arranging the second housing 8, both the water pump 7 and the drive assembly 2 can be accommodated, while the drinking bowl 3 is arranged externally, thereby preventing the water pump 7 and the drive assembly 2 from being exposed to an exterior environment and avoiding adverse effects of the external environment on the water pump 7 and the drive assembly 2.

Preferably, the second housing 8 may serve as a main control box. The pet water dispenser further includes the above main control board 10. The main control board 10, the water pump 7, and the drive assembly 2 are all accommodated within the second space. Buttons on the main control board 10 are arranged to pass through an upper cover of the second housing 8.

In this embodiment, the rotating assembly 202, along a rotational path thereof, defines at least a first position corresponding to a state in which the drinking bowl 3 is configured to contain water and a second position corresponding to a state in which the drinking bowl 3 is configured to pour out water. Under the driving of the drive motor 201, the rotating assembly 202 is configured to perform reciprocating movement between the first position and the second position. The drive assembly 2 further includes a position detection assembly 9. The position detection assembly 9 is communicatively connected to the drive motor 201 and is configured to transmit a signal indicating that the rotating assembly 202 rotates to the first position or the second position to the drive motor 201. It should be understood that the reciprocating movement of the drinking bowl 3 between the first position and the second position requires forward and reverse rotation of the drive motor 201. In this embodiment, by arranging the position detection assembly 9, the detected signal indicating that the rotating assembly 202 has rotated to the first position and the second position can be transmitted to the drive motor 201. In this way, upon receiving a signal, the drive motor 201 may change its state. For example, when the rotating assembly 202 rotates from the first position to the second position, the position detection assembly 9 detects that the rotating assembly 202 is at the second position, and the drive motor 201 may stop further driving the rotating assembly 202 to rotate, and subsequently the rotating assembly 202 is driven to rotate from the second position back to the first position, in which case, the position detection assembly 9 detects that the rotating assembly 202 is at the first position, and the drive motor 201 stops driving, thereby preventing excessive rotation of the rotating assembly 202.

In this embodiment, the position detection assembly 9 includes a sensing member 901, a first position detection element 902, and a second position detection element 903. The sensing member 901 is connected to the rotating assembly 202 to rotate along with the rotating assembly 202. The sensing member 901, along a rotational path thereof, defines at least a third position corresponding to the first position and a fourth position corresponding to the second position. The first position detection element 902 and the second position detection element 903 are both communicatively connected to the drive motor 201. The first position detection element 902 is configured to detect that the sensing member 901 is located at the third position and transmit a signal indicating that the sensing member 901 is located at the third position to the drive motor 201. The second position detection element 903 is configured to detect that the sensing member 901 is located at the fourth position and transmit a signal indicating that the sensing member 901 is located at the fourth position to the drive motor 201.

In this embodiment, the position detection assembly 9 includes a sensing member 901, a first position detection element 902, and a second position detection element 903. Specifically, the sensing member 901 is configured to rotate along with the rotating assembly 202, such that when the rotating assembly 202 rotates to the first position and the second position, there are corresponding specific positions, namely the third position and the fourth position. The first position detection element 902 and the second position detection element 903 are configured to respectively detect the third position and the fourth position, thereby determining a position of the rotating assembly 202. With this configuration, the position detection assembly 9 can be used as a complete set, without the need for structural modification on the rotating assembly 202, thereby facilitating manufacturing, installation and disassembly.

In one embodiment, both the first position detection element 902 and the second position detection element 903 may be photoelectric switches. The sensing member 901 is provided with a protruding portion capable of being inserted into the photoelectric switch. When the sensing member 901 is located at the third position, the protruding portion is inserted into the first position detection element 902. Similarly, when the sensing member 901 is located at the fourth position, the protruding portion is inserted into the second position detection element 903. In another embodiment, both the first position detection element 902 and the second position detection element 903 may be Hall sensors. A magnetic member is installed on the protruding portion of the sensing member 901, or the protruding portion itself is a magnetic member, such that when the sensing member 901 is located at the third position and the fourth position respectively, it can be detected by the first position detection element 902 and the second position detection element 903, respectively. Alternatively, one of the first position detection element 902 and the second position detection element 903 may be a photoelectric switch, and the other may be a Hall sensor. Naturally, other forms of sensing or detection elements may also be used.

Specifically, the sensing member 901 may be a sector-shaped structural member, and a ring is disposed at a center thereof, and sleeved over and secured to the rotating assembly 202. With this configuration, opposite corner portions of the sensing member 901 may serve as the protruding portions.

More specifically, the drive assembly 2 may further include a front housing 204 and a rear housing 205. The rotating assembly 202 extends through the front housing 204 and the rear housing 205, and the front housing 204 is configured to be snap-fitted with the rear housing 205, thereby supporting the rotating assembly 202. One end of the load cell 1 extends through the front housing 204 and is connected to the rotating assembly 202. The first position detection element 902 and the second position detection element 903 are both mounted on the rear housing 205, and the sensing member 901 is located on a side of the rear housing 205 away from the front housing 204.

The beneficial effects of the present disclosure are as follows: through an innovative structural design, the present disclosure arranges the load cell 1 between the drinking bowl 3 and the drive assembly 2, thereby forming a dual-function metering system. When a pet is drinking water, the load cell 1 acquires single water intake volume data in real time. After the drinking bowl 3 completes liquid pouring through the rotating assembly 202, the pet water dispenser of the present disclosure leverages the mechanical characteristics of no-load reset of a bowl body to automatically trigger a sensor zero-point calibration procedure, thereby effectively eliminating cumulative errors caused by material creep, temperature drift, or long-term loading of the load cell itself. The present disclosure innovatively addresses the problem of irreversible creep distortion caused by continuous exerted by the water tank on the load cell in traditional pet water dispensers, and simultaneously breaks through the limitation in the prior art that automatic periodic calibration cannot be implemented.

The above description is only specific embodiments of the present disclosure. However, the scope of protection of the present disclosure is not limited thereto. Any modifications or substitutions that can be easily conceived by those skilled in the art within the technical scope disclosed herein shall fall within the scope of protection of the present disclosure. Therefore, the scope of protection of the present disclosure shall be subject to the scope of the claims hereof.

What is claimed is:

1. A self-calibrating rotary weighing structure, comprising a load cell, a drive assembly, and a drinking bowl, wherein one end of the load cell is connected to the drive assembly, and the other end of the load cell is connected to the drinking bowl; the end of the load cell connected to the drinking bowl is disposed in a suspended manner, the drive assembly is configured to drive the drinking bowl to rotate through the load cell, thereby enabling liquid in the drinking bowl to be poured out and allowing the drinking bowl to return to an upright position for refilling with water.

2. The self-calibrating rotary weighing structure according to claim 1, further comprising a bowl connecting member and a bushing assembly, wherein the drinking bowl is mounted on one end of the bushing assembly via the bowl connecting member, and the load cell is detachably mounted on the other end of the bushing assembly; and the load cell is a beam-type load cell.

3. The self-calibrating rotary weighing structure according to claim 2, wherein the bushing assembly comprises a first bushing and a second bushing; the first bushing is sleeved over the second bushing, the first bushing is provided with a first hole, and the second bushing is provided with a second hole; the first hole is in fluid communication with the second hole, such that an inner cavity of the first bushing is in fluid communication with an exterior through the second hole; and the bowl connecting member is detachably mounted beneath the first bushing, the second bushing is provided with a load cell mounting hole, and the load cell is detachably mounted within the load cell mounting hole.

4. The self-calibrating rotary weighing structure according to claim 1, wherein the drive assembly comprises a drive motor and a rotating assembly, and the drive motor is connected to one end of the rotating assembly, such that the drive motor drives the rotating assembly to rotate; and the other end of the rotating assembly is connected to the load cell.

5. The self-calibrating rotary weighing structure according to claim 4, wherein the drive assembly further comprises a transmission assembly, and the drive motor is connected to one end of the rotating assembly via the transmission assembly, such that the drive motor drives the rotating assembly to rotate; and the other end of the rotating assembly is connected to the load cell.

6. A pet water dispenser incorporating the self-calibrating rotary weighing structure according to claim 1, comprising a first housing and a water pump, wherein the first housing is provided with a first space configured to contain clean water, one end of the water pump is in fluid communication with the first space, and the other end of the water pump is in fluid communication with the drinking bowl; and the water pump is configured to pump the clean water from the first space into the drinking bowl.

7. A pet water dispenser incorporating the self-calibrating rotary weighing structure according to claim 3, comprising a first housing and a water pump, wherein the first housing is provided with a first space configured to contain clean water, one end of the water pump is in fluid communication with the first space, and the other end of the water pump is in fluid communication with the drinking bowl; and the water pump is configured to pump the clean water from the first space into the drinking bowl.

8. The pet water dispenser according to claim 7, wherein the water pump is in fluid communication with the first hole and the second hole, thereby communicating with the drinking bowl through the first hole, the second hole, and the inner cavity of the first bushing.

9. The pet water dispenser according to claim 7, further comprising a second housing, wherein the second housing is provided with a second space, and the water pump and the drive assembly are both accommodated within the second space; a third hole is formed in a side wall of the second housing, the bushing assembly passes through the third hole, and a gap is formed between the bushing assembly and a hole wall of the third hole, such that the bushing assembly is spaced apart from the hole wall of the third hole under a pressure exerted by the drinking bowl.

10. The pet water dispenser according to claim 7, wherein the rotating assembly, along a rotational path thereof, defines at least a first position corresponding to a state in which the drinking bowl is configured to contain water, and a second position corresponding to a state in which the drinking bowl is configured to pour out water; under the driving of the drive motor, the rotating assembly is configured to perform reciprocating movement between the first position and the second position; the drive assembly further comprises a position detection assembly; the position detection assembly is communicatively connected to the drive motor and is configured to transmit a signal indicating that the rotating assembly rotates to the first position and the second position to the drive motor; the position detection assembly comprises a sensing member, a first position detection element, and a second position detection element; the sensing member is connected to the rotating assembly to rotate along with the rotating assembly; the sensing member defines, along a rotational path thereof, at least a third position corresponding to the first position, and a fourth position corresponding to the second position; the first position detection element and the second position detection element are both communicatively connected to the drive motor; the first position detection element is configured to detect that the sensing member is located at the third position and transmit a signal indicating that the sensing member is located at the third position to the drive motor; and the second position detection element is configured to detect that the sensing member is located at the fourth position and transmit a signal indicating that the sensing member is located at the fourth position to the drive motor.
